(19) United States
(12) Patent Application Publication
(10) Pub. No.: US 2023/0172420 A1
(43) Pub. Date: Jun. 8, 2023

(54) INSULATION DEVICE, DOMESTIC APPLIANCE, AND METHOD

(71) Applicant: BSH Hausgeräte GmbH, Munich (DE)

(72) Inventors: Alexander Sing, Wittislingen (DE); Sami Bisgin, Dillingen (DE); Michael Fickler, Augsburg (DE); Maximilian Hessel, München (DE)

(21) Appl. No.: 17/912,877

(22) PCT Filed: Mar. 11, 2021
(86) PCT No.: PCT/EP2021/056172

§ 371 Date: Sep. 20, 2022

(30) Foreign Application Priority Data
Mar. 30, 2020 (DE) 102020204084.2

(51) Int. Cl. A47L 15/42; B32B 5/18; B32B 27/40; B32B 27/20

(52) U.S. Cl. CPC A47L 15/4209; B32B 5/18; B32B 27/40; B32B 27/20; B32B 2264/10; B32B 2307/102; B32B 2509/00; B32B 2266/0278; B32B 2307/72; B29C 44/12

(57) ABSTRACT

An insulation device for a receiving area of a household appliance includes an insulation element made of a viscoelastic polyurethane foam for acoustically insulating the receiving area, and a stiffening element stiffening the insulation element and firmly connected to the insulation element.

The present invention relates to an insulation device for a receiving area of a household appliance, in particular a water-guiding household appliance, a household appliance, in particular a water-guiding household appliance, having such an insulation device and a method for manufacturing such an insulation device.

During the operation of a household dishwasher, there are many sound sources which may lead to a sound emission. This sound reaches the ear of a user and may be perceived negatively by the user. One possibility for reducing the sound is to reduce the sound emission at the sound source and thus to reduce the sound pressure entering the ear of the user. However, this is not always possible in a satisfactory manner, primarily in the case of sound events which are based on stochastic events or which may be influenced by the user. This may be the case, for example, with a spray jet in the interior of a washing container of the household dishwasher. A deflection of the spray jet is significantly influenced by the variable arrangement of items to be washed in the washing container. Thus it is not possible to prevent the spray jet from striking directly against the washing container. It is also not possible to specify at which point and at which angle the spray jet strikes against the washing container.

When designing the acoustic isolation, therefore, it has to be taken into account that an excitation of structure-borne sound may occur at any point of the washing container. Thus in the case of particularly quiet household dishwashers, provided it is possible technically and structurally, every point of the washing container has to be covered with an acoustically effective material in order to counteract this unavoidable excitation in an effective manner. These materials which are applied directly to the washing container primarily serve to dampen the structure-borne sound which is excited in the metal of the washing container or to dampen the structural vibrations thereof. In other words, the vibration amplitude of the surface, which is produced by the excitation in the interior of the washing container, is reduced by these acoustically effective materials. The energy of the structure-borne sound in this case is converted into heat in the acoustically effective material.

The in-house prior art, in which bitumen mats with a hot-melt adhesive coating are directly fused onto the washing container by the effect of temperature, is known to the applicant. These bitumen mats produce thereby a permanent bond with the sheet metal of the washing container. A further possibility is the use of polyurethanes. Such polyurethanes may be directly applied to the washing container in order to dampen the structure-borne sound and the structural vibrations.

The in-house prior art, in which isolating components are directly injected as liquid into a hollow component before the curing and/or cross-linking, is also known to the applicant. In the defined volume of the hollow component, the liquid reacts, forming the isolating component. In this case, the component layers surrounding the isolating component have to be already joined before the liquid forming the isolating component is injected. This is implemented primarily in refrigerators for the thermal insulation of an interior of the refrigerator relative to the surroundings. In this case, the isolating component also serves for stabilizing the refrigerator. To this end, substantially closed-cell rigid foam is used as the isolating component. This provides a high degree of stiffness due to its structure. Alternatively, isolating components may be produced separately, and mounted by being positioned, clamped or adhesively bonded onto a household appliance. To this end, these isolating components have to be manufactured in a molding tool and subsequently attached to the household appliance.

The publication EP 3 092 935 A1 discloses an arrangement for the acoustic and thermal insulation of a receiving area of a water-guiding household appliance. The arrangement comprises a first insulation element which is designed to insulate a receiving area thermally, and a second insulation element which is designed to insulate the receiving area acoustically, wherein the first insulation element is arranged between the receiving area and the second insulation element. In this case, the first insulation element is directly foamed onto the receiving area.

Against this background, an object of the present invention is to provide an improved insulation device for a household appliance.

Accordingly, an insulation device for a receiving area of a household appliance, in particular for a water-guiding household appliance, is proposed. The insulation device comprises an insulation element made of a viscoelastic polyurethane foam for acoustically insulating the receiving area and a stiffening element stiffening the insulation element and firmly connected to the insulation element.

As the insulation device has the stiffening element, the insulation device is able to be handled more easily for mounting on the receiving area. Moreover, the stiffening element covers a sticky surface of the viscoelastic polyurethane foam so that a user may not come into contact therewith.

The receiving area may be, in particular, a washing container of a household dishwasher. In other words, the household appliance is preferably a household dishwasher. “Viscoelasticity” may be understood to mean in the present case a partially elastic, partially viscous material behavior. Viscoelastic materials thus combine features of solids and liquids therein. The insulation device is preferably suitable for the acoustic and/or thermal insulation or isolation of the receiving area. Thus the insulation device may also be denoted as the isolating device, in particular as the acoustic and/or thermal isolating device.

The polyurethane foam comprises, in particular, a matrix material, namely a polyurethane, which is penetrated by a plurality of cells or pores in order to form the polyurethane foam in this manner. The pores may be filled with gas, in particular filled with air. The polyurethane foam may be open-pored or closed-pored. “Open-pored” means in the present case that the pores are connected together. In other words, the polyurethane foam may be spongy. “Closed-pored” means in the present case that the pores are not connected together. The polyurethane foam may be manufactured by mixing polyurethane basic components, namely an isocyanate and a polyol, optionally with the addition of a propellant.

According to one embodiment, the polyurethane foam at 40° C. and at a frequency of 100 to 800 Hz has a loss factor of greater than 0.2, preferably of greater than 0.35, further preferably of greater than 0.5.

In the present case, the “loss factor” is to be understood to mean, with different types of physical vibrations, the relationship between the imaginary part, which is subject to loss, and the loss-free real part of a complex variable. The higher the loss factor, the greater the acoustic insulating capacity of the insulation device. In particular, the insulation element is suitable for converting structure-borne sound into heat.

According to a further embodiment, the polyurethane foam has a thermal conductivity of between 20 and 80 mW/(m*K), preferably of between 40 and 60 mW/(m*K), further preferably of between 50 and 60 mW/(m*K).

In other words, the insulation device as mentioned above also has thermal insulating properties or thermal isolating properties. The thermal conductivity of the polyurethane foam is lower, the more pores it has or the lower the proportion of the matrix material in the polyurethane foam.

According to a further embodiment, the polyurethane foam has a density of less than 300 kg/m³, preferably of less than 250 kg/m³, further preferably of less than 200 kg/m³.

The greater the proportion of pores or the lower the proportion of matrix material in the polyurethane foam, the lower the density thereof. Due to the stiffening element which is connected to the insulation element, the insulation device is still able to be handled even if the insulation element has a very low density and does not exhibit any flexural rigidity.

According to a further embodiment, a thickness of the insulation element is greater than 2 mm, preferably greater than 10 mm, further preferably greater than 15 mm.

The insulation element may also have a thickness of, for example, 20 to 50 mm or more.

According to a further embodiment, a thickness of the stiffening element is less than 10 mm, preferably less than 5 mm, further preferably less than 1 mm.

Preferably, the thickness of the stiffening element is smaller by a multiple than the thickness of the insulation element. If the stiffening element has a thickness of less than 1 mm, this stiffening element is preferably made of very stiff material, such as for example a metal sheet.

According to a further embodiment, the stiffening element is part of the receiving area, and is made of bitumen, made of sheet metal, made of paper, made of cardboard, made of aluminum board, made of plastics, in particular of a plastics film, or made of wood.

Any combination of the aforementioned materials may be used. If the stiffening element is part of the receiving area, the stiffening element, for example, may be a door, in particular an inner door, of the receiving area. Moreover, the stiffening element may also be, for example, a ceiling, a side wall, or a rear wall of the receiving area.

According to a further embodiment, particles are embedded in the polyurethane foam.

The particles preferably have a greater density than the polyurethane foam or the matrix material. The particles thus form mass points in the polyurethane foam, whereby the loss factor may be varied, in particular increased. The particles may be, for example, metal particles, stone particles, or graphite particles, in particular expandable graphite particles. In the last case, therefore, the particles also have intumescent properties. The particles may, however, also be plastics particles. In this case, however, the particles have a greater density than the matrix material or than the polyurethane foam.

According to a further embodiment, the polyurethane foam is directly foamed onto the stiffening element.

To this end, the stiffening element may be inserted, for example, into a mold. A mixture of the aforementioned polyurethane components may be applied to the stiffening element. The polyurethane foam, which is formed by a chemical reaction of the basic components, is then connected directly to the stiffening element. To this end, the stiffening element may be roughened, for example. Moreover, chemical additives which generate an unreleasable bond between the polyurethane foam and the stiffening layer may also be added to the mixture. The polyurethane foam may also be adhesively bonded or fused to the stiffening element.

Moreover, a household appliance, in particular a water-guiding household appliance, having a receiving area and such an insulation device is proposed, wherein the insulation device is attached to the receiving area such that the insulation element bears against the receiving area.

In other words, the insulation element is arranged between the receiving area and the stiffening element. The insulation device may be adhesively bonded, for example, onto the receiving area, fused thereon or simply positioned thereon. The household appliance, as mentioned above, in particular is a household dishwasher. The household appliance, however, may also be a household washing machine, a stove, an oven, a refrigerator or the like. The receiving area is, in particular, a washing container of a household dishwasher. The receiving area is preferably cube-shaped or cuboidal and comprises a bottom, a ceiling arranged opposite the bottom, two side walls arranged opposite one another, a rear wall and a door arranged opposite the rear wall. The insulation element may be provided, for example, on the side walls, on the rear wall, on the ceiling and on the door. To this end, a plurality of insulation elements may be provided. However, alternatively the insulation element may also be provided, for example, only on the ceiling or only on the side walls.

Moreover, a method for manufacturing an insulation device for a receiving area of a household appliance, in particular a water-guiding household appliance, is proposed. The method comprises the steps: a) inserting a stiffening element into a mold, b) introducing a mixture of polyurethane basic components into the mold, c) reacting and foaming the mixture to form a viscoelastic polyurethane foam in order to foam the insulation element made of the polyurethane foam onto the stiffening element, and thus to form the insulation device, and d) demolding the insulation device.

The mold comprises, in particular, a mold lower part and a mold upper part positioned onto the mold lower part. The mold upper part may be lifted away from the mold lower part. Both the mold lower part and the mold upper part have a cavity. The stiffening element may be inserted into the cavity of the mold lower part. The cavity of the mold upper part is foamed with the viscoelastic polyurethane foam. The polyurethane basic components may be an isocyanate, a polyol and optionally a propellant. After mixing the polyurethane basic components to form the mixture, this is introduced as liquid into the mold, for example poured therein. The polyurethane basic components then react chemically with one another, whereby the pores are formed in the mixture and the mixture is foamed to form the viscoelastic polyurethane foam. For demolding the insulation device, the mold upper part is lifted away from the mold lower part and the insulation device is removed from the mold lower part.

According to one embodiment, in step a) at least one part of the receiving area is inserted into the mold as the stiffening element.

In other words, the part of the receiving area functions as the stiffening element. In this case, a separate stiffening element is not required.

According to a further embodiment, in step a) a door of the receiving area is inserted into the mold as the stiffening element.

In particular, an inner door is inserted into the mold as a sheet metal bent part, wherein the insulation element is then directly foamed onto the door, in particular the inner door.

According to a further embodiment, in step a) a plate, which may be reshaped to form the receiving area, is inserted into the mold as the stiffening element.

The plate may be, for example, a stainless steel plate. The plate may have any cutouts or through-passages. In the mold, preferably a plurality of insulation elements are foamed onto the plate.

According to a further embodiment, the method also comprises a step e), carried out after step d), of reshaping the plate to the receiving area.

This may be carried out, for example, in a deep-drawing tool. In other words, the insulation device does not have to be separately mounted again onto the finished receiving area.

Further possible implementations of the insulation device, of the household appliance and/or of the method also comprise not explicitly mentioned combinations of features or embodiments, which are described above or below relative to the exemplary embodiments. In this case, the person skilled in the art will also consider individual aspects as improvements or additions to the respective basic form of the insulation device, the household appliance and/or the method.

Further advantageous embodiments and aspects of the insulation device, the household appliance and/or the method form the subject of the subclaims and the exemplary embodiments of the insulation device, the household appliance and/or the method described below. Moreover, the insulation device, the household appliance and/or the method are described in more detail by way of preferred embodiments with reference to the accompanying figures.

In the figures:

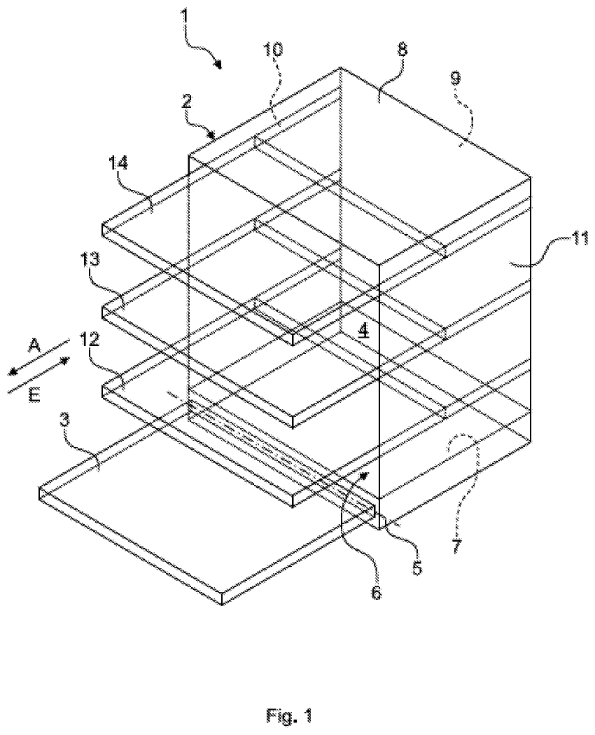

FIG. 1 shows a schematic perspective view of an embodiment of a household appliance;

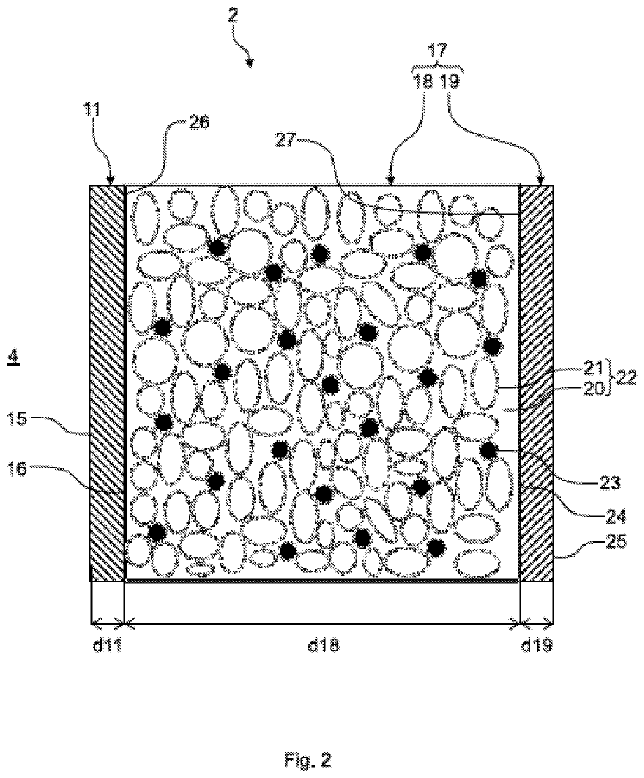

FIG. 2 shows a highly enlarged schematic sectional view of a receiving area for the household appliance according to FIG. 1;

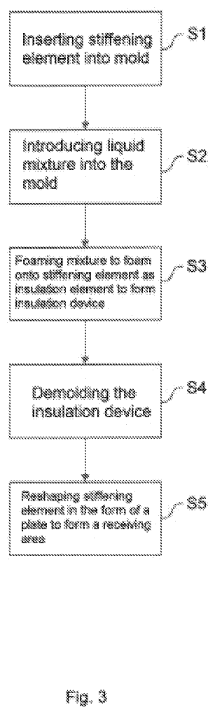

FIG. 3 shows a schematic block diagram of a method for manufacturing an insulation device for the receiving area according to FIG. 2;

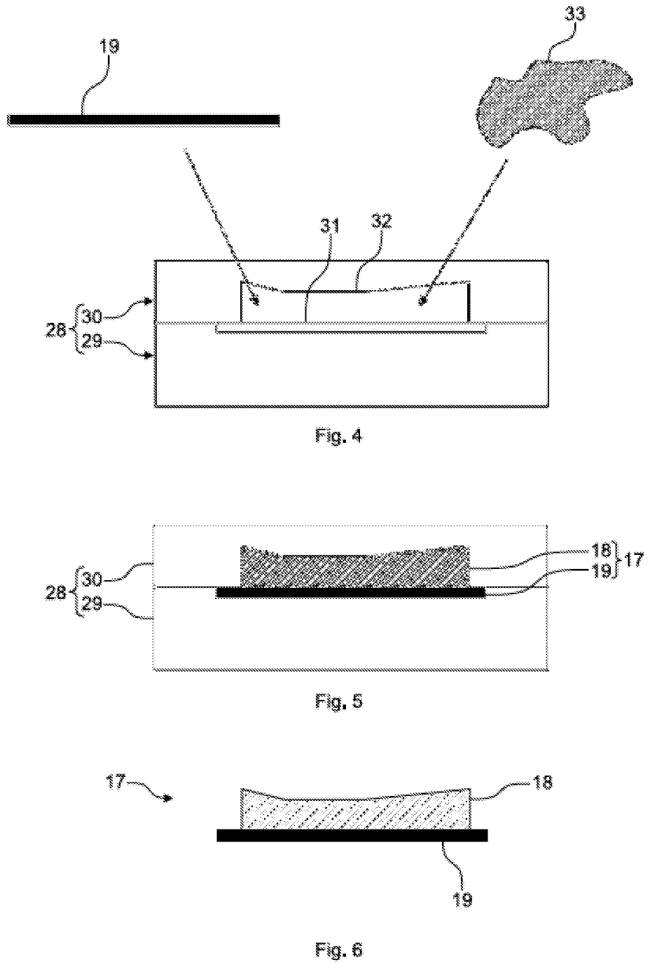

FIG. 4 shows a schematic sectional view of an embodiment of a mold for manufacturing an insulation device for the receiving area according to FIG. 2

FIG. 5 shows a further schematic sectional view of the mold according to FIG. 4;

FIG. 6 shows a schematic sectional view of an embodiment of an insulation device for the receiving area according to FIG. 2;

FIG. 7 shows a schematic sectional view of a further embodiment of a mold for manufacturing an insulation device for the receiving area according to FIG. 2;

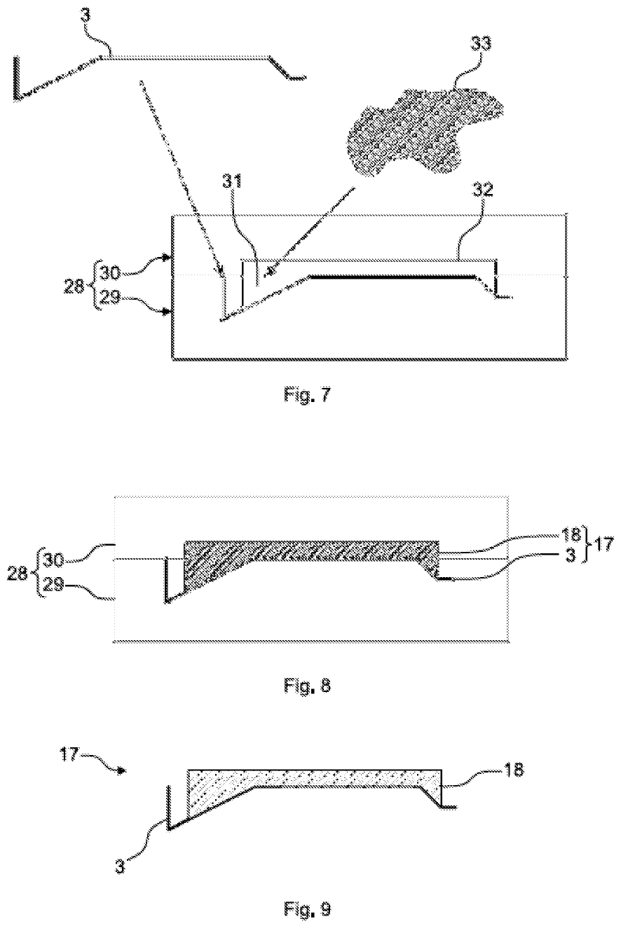

FIG. 8 shows a further schematic sectional view of the mold according to FIG. 7;

FIG. 9 shows a schematic sectional view of a further embodiment of an insulation element for the receiving area according to FIG. 2;

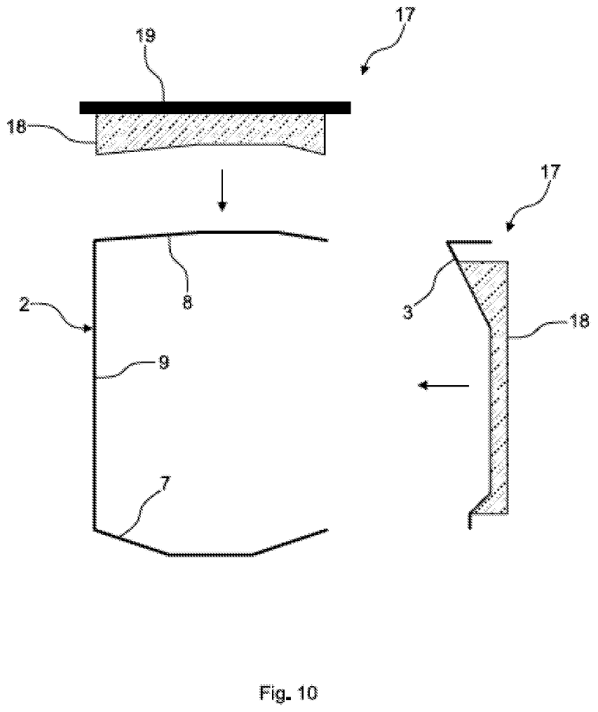

FIG. 10 shows a schematic exploded view of an embodiment of the receiving area according to FIG. 2;

FIG. 11 shows a schematic sectional view of a further embodiment of a mold for manufacturing an insulation device for the receiving area according to FIG. 2;

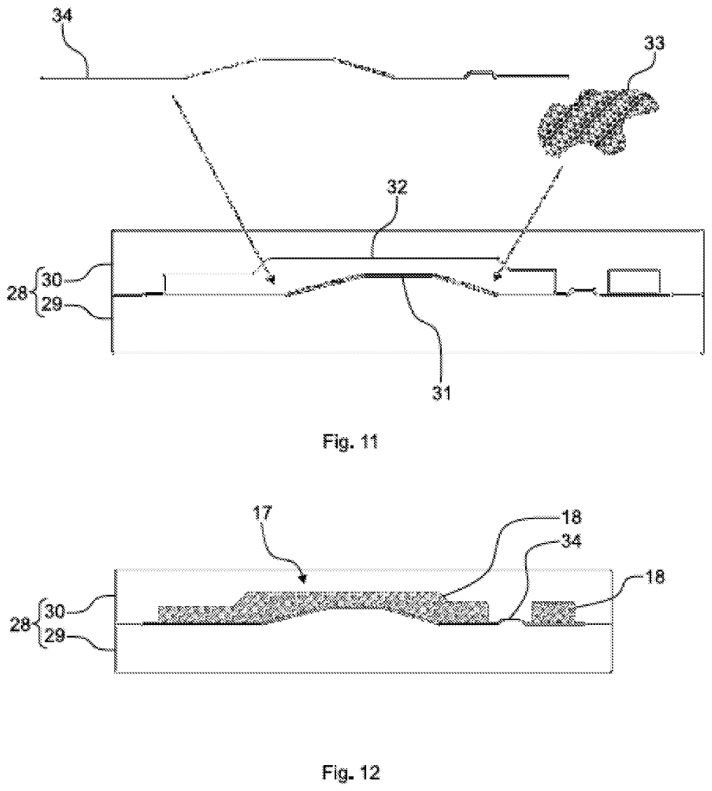

FIG. 12 shows a further schematic sectional view of the mold according to FIG. 11;

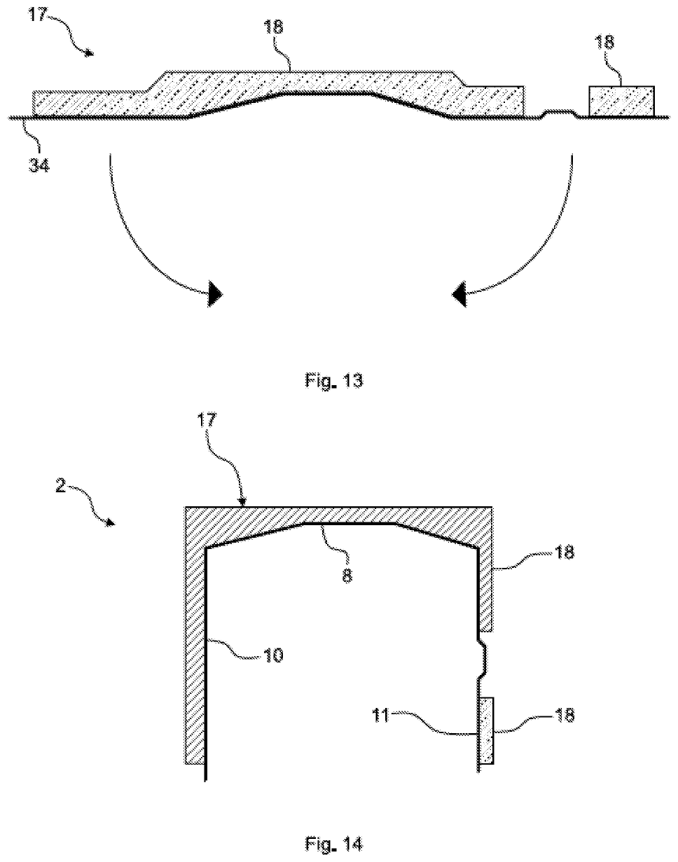

FIG. 13 shows a schematic sectional view of a further embodiment of an insulation device for the receiving area according to FIG. 2; and

FIG. 14 shows a schematic sectional view of the receiving area according to FIG. 2.

Elements which are the same or functionally the same have been provided in the figures with the same reference numerals, unless specified otherwise.

FIG. 1 shows a schematic perspective view of an embodiment of a household appliance 1. The household appliance 1 is, in particular, a water-guiding household appliance, such as for example a household dishwasher or a household washing machine. The household appliance 1, however, may also be a refrigerator, a stove, an oven or the like. Hereinafter, however, it is assumed that the household appliance 1 is a household dishwasher.

The household appliance 1 has a receiving area 2 which is able to be closed by a door 3, in particular in a water-tight manner. To this end, a sealing device may be provided between the door 3 and the receiving area 2. The receiving area 2 is preferably cuboidal. The receiving area 2 may be a washing container. The receiving area 2 may be arranged in a housing of the household appliance 1. The receiving area 2 and the door 3 may form a washing chamber 4 for washing items to be washed.

The door 3 is shown in FIG. 1 in the open position thereof. The door 3 may be closed or opened by pivoting about a pivot axis 5 provided at a lower end of the door 3. A loading opening 6 of the receiving area 2 may be closed or opened by means of the door 3. The receiving area 2 has a bottom 7, a ceiling 8 arranged opposite the bottom 7, a rear wall 9 arranged opposite the closed door 3 and two side walls 10, 11 arranged opposite one another. The bottom 7, the ceiling 8, the rear wall 9 and the side walls 10, 11 may be produced, for example, from a stainless steel sheet. The bottom 7 may be produced alternatively from a plastics material, for example.

The household appliance 1 also has at least one receptacle for items to be washed 12 to 14. Preferably, a plurality of receptacles for items to be washed 12 to 14, for example three thereof, may be provided, wherein the receptacle for items to be washed 12 may be a lower receptacle for items to be washed or a lower basket, the receptacle for items to be washed 13 may be an upper receptacle for items to be washed or an upper basket, and the receptacle for items to be washed 14 may be a cutlery drawer. As FIG. 1 also shows, the receptacles for items to be washed 12 to 14 are arranged one above the other in the receiving area 2. Each receptacle for items to be washed 12 to 14 is able to be displaced selectively into or out of the receiving area 2. In particular, each receptacle for items to be washed 12 to 14 is able to be pushed or moved in a push-in direction E (arrow) into the receiving area 2 and pulled or moved out of the receiving area 2 in a pull-out direction A (arrow) counter to the push-in direction E (arrow).

FIG. 2 shows a highly enlarged schematic sectional view of an embodiment of the receiving area 2. In particular, only a detail of the side wall 11 is shown in FIG. 2. As mentioned above, the side wall 11 may be produced, for example, from a stainless steel sheet. The side wall 11 comprises an inner face 15 facing the washing chamber 4 and an outer face 16 facing away from the washing chamber 4. The inner face 15 and the outer face 16 are positioned parallel to one another. The side wall 11 has a thickness d11. The thickness d11 may be, for example, 0.2 to 1 mm.

An insulation device 17 for the thermal and/or acoustic insulation of the receiving area 2 is also shown in FIG. 2. The insulation device 17 serves for the thermal isolation and/or sound isolation of the receiving area 2 and may thus also be denoted as a thermal and/or acoustic isolating device. The insulation device 17 comprises an insulation element 18 and a stiffening element 19 for stiffening the insulation element 18. The stiffening element 19 is fixedly connected to the insulation element 18.

The insulation element 18 is made of a foam material, in particular of a viscoelastic foam material, and comprises a matrix material 20, namely polyurethane, which is penetrated by plurality of cells, cavities or pores 21. The pores 21 may have any geometry. For example, the pores 21 may be spherical or ellipsoidal. The matrix material 20 together with the pores 21 form a polyurethane foam 22. The polyurethane foam 22 may open-pored or closed-pored. In other words, the pores 21 are either connected together or not connected together.

Moreover, particles 23 are embedded in the matrix material 20. The particles 23 are arranged so as to be evenly distributed in the matrix material 20. The particles 23 may comprise, for example, metal powder, stone powder, graphite, in particular expandable graphite, plastics or other suitable materials. In this case, however, the particles 23 have a greater density than the matrix material 20. As a result, the particles 23 act as mass points in the insulation element 18, whereby the loss factor of the insulation element 18 is increased. The “loss factor” in the present case, with different types of physical vibrations, is to be understood as the relationship between the imaginary part, which is subject to loss, and the loss-free real part of a complex variable.

The polyurethane foam 22, in particular the insulation element 18, at 40° C. and at a frequency of 100 to 800 Hz has a loss factor of greater than 0.2, preferably of greater than 0.35, further preferably of greater than 0.5. In particular, the polyurethane foam 22 has a thermal conductivity of between 20 and 80 mW/(m*K), preferably of between 40 and 60 mW/(m*K), further preferably of between 50 and 60 mW/(m*K).

The insulation device 17 is provided, in particular, on the outer face 16 of the side wall 11. In this case, the insulation element 18, for example, may be adhesively bonded to the outer face 16, fused thereon or even directly foamed thereon. The insulation device 17 may also be simply positioned on the receiving area 2. The insulation element 18 comprises a thickness d18. The thickness d18 is greater than the thickness d11. For example, the thickness d18 is more than 2 mm, preferably more than 10 mm, further preferably more than 15 mm.

The stiffening element 19 comprises an inner face 24 on which the insulation element 18 is preferably directly foamed, and an outer face 25 facing away from the insulation element 18. The insulation element 18 comprises a surface 26 which is connected to the side wall 11 and a surface 27 which is connected to the stiffening element 19. The stiffening element 19 has a thickness d19. The thickness d19 is less than the thickness d18. Preferably, the thickness d19 is less than 10 mm, preferably less than 5 mm, further preferably less than 1 mm. If the thickness d19 is less than 1 mm, for example, a steel sheet is used as the material for the stiffening element 19.

The polyurethane foam 22 has a density of less than 300 kg/m³, preferably of less than 250 kg/m³, further preferably of less than 200 kg/m³. The particles 23, however, have a greater density than the polyurethane foam 22 and than the matrix material 20. For example, the particles 23 may have a density of between 500 and 8000 kg/m³, in particular of 2200 kg/m³. In particular, the particles 23 also have a greater modulus of elasticity than the matrix material 20 or than the polyurethane foam 22. The particles 23 comprise, in particular, a particle size of less than 500 μm.

The stiffening element 19 may be a bitumen mat or bitumen plate. Moreover, the stiffening element 19 may also be a metal plate, or made of paper or cardboard or aluminum board. The stiffening element 19 may also be made of plastics, in particular of a plastics film, or of wood. Moreover, the stiffening element 19, in contrast to that shown in FIG. 2, may also be part of the receiving area 2. For example, the side wall 11 itself may function as the stiffening element 19.

By means of the stiffening element 19 it is possible to stiffen the insulation device 17 so that said insulation device may be easily handled and preferably mounted in an automated manner on the receiving area 2. Without the stiffening element 19, due to its foam structure and its low density, the insulation element 18 has a very low flexural rigidity which would hamper the handling.

During the manufacture of the household appliance 1, it is necessary to produce the insulation device 17 and to mount it on the receiving area 2. Due to the small thickness d18, the low inherent stability and the high level of stickiness of the insulation element 18 made of the viscoelastic polyurethane foam 22, an operationally reliable mounting is difficult to ensure. The sticky and non-rigid insulation element 18 is not able to be reliably mounted, either manually or automatically. Due to the stiffening of the insulation device 17 with the stiffening element 19, the mountability is significantly improved and a more advantageous, more stable production process is possible. In this case, the stiffness of the stiffening element 19 is greater than that of the insulation element 18 itself.

In the case of flat components, such as for example the door 3 of the household appliance 1, the thickness d18 of the insulation element 18 is thicker in many regions than the thickness d19 of the stiffening element 19. As mentioned above, the thickness d18 of the insulation element 18 is greater than 2 mm, preferably greater than 10 mm, in particular greater than 15 mm. The thickness d19 of the stiffening element is less than 10 mm, preferably less than 5 mm. A very small thickness d19 of less than 1 mm is also conceivable. As a result, in particular, material may be saved. However, care has to be taken that the stiffness of the stiffening element 19 is selected to be correspondingly high. The insulation device 17 is stiffened by means of the stiffening element 19. Thus a change to the dimensions within the elastic range is no longer possible. The possibility of an operationally reliable production of the insulation device 17 is enhanced.

The unstiffened surface 26 of the insulation element 18 is produced as an open component for improved demolding, handling during mounting, and subsequent recyclability. This is achieved by applying a parting layer into a mold, in which the insulation device 17 is produced. This parting layer may be of liquid or solid form and applied by positioning, spraying, atomizing or the like. For example, a parting film or a parting agent may be used. This parting layer may also undertake functional tasks such as sealing against steam, positioning, guiding and shielding of components, such as for example cables. The parting layer is able to ensure by its design a clean positioning of the subassembly in the mounted targeted position. The parting layer may conceal undesired properties of the insulation element 18 from the user. Undesired properties, for example, might be the stickiness or the soft structure of the polyurethane foam 22.

FIG. 3 shows a schematic block diagram of a method for manufacturing the insulation device 17. FIGS. 4 to 6 show the stepwise manufacture of the insulation device 17 by means of a mold 28. Hereinafter, reference is made to FIGS. 3 to 6 at the same time.

Initially, in a step S1 the stiffening element 19 is inserted into the mold 28. The mold 28 is a casting mold or die. The mold 28 has a mold lower part 29 and a mold upper part 30 which is arranged on the mold lower part 29. The mold upper part 30 may be lifted away from the mold lower part 29, so that the stiffening element 19 may be inserted into the mold 28. The mold lower part 29 comprises a cavity 31 for receiving the stiffening element 19. The mold upper part 30 comprises a cavity 32 in which the insulation element 18 is received after the manufacture of the insulation device 17.

After inserting the stiffening element 19 and closing the mold 28, a liquid mixture 33 consisting of basic components of the polyurethane foam 22 are introduced into the mold 28. This takes place in a step S2. The liquid mixture 33 may be cast into the cavity 32, for example, through an opening provided in the mold upper part 30. The mixture 33 in the present case is a mixture of two basic components, namely an isocyanate and a polyol. A propellant may be also added to the mixture 33, which leads to degassing. As a result, the polyurethane foam 22 is produced from the mixture 33 during the course of the chemical reaction of the two basic components.

In other words, in a step S3 the mixture 33 is foamed to form the viscoelastic polyurethane foam 22 in order to foam the insulation element 18 onto the stiffening element 19 and thus to form the insulation device 17. After the curing and/or cross-linking of the mixture 33, the insulation device 17, as shown in FIG. 6, is demolded in a step S4. To this end, the mold upper part 30 is lifted away from the mold lower part 29 and the insulation device 17 is removed from the mold lower part 29.

In other words, the insulation device 17 is directly formed on or adjacent to the stiffening element 19 by the reaction of the basic components of the polyurethane foam 22. By the adhesive forces produced during the reaction, a stable bond is produced between the insulation element 18 and the stiffening element 19. The stiffening element 19 also conceals the sticky surface 27 of the insulation element 18. This results in advantages for handling or mounting the insulation device 17. For example, the insulation device 17 may be mounted on the side of the stiffening element 19.

Moreover, the insulation element 18 is shielded thereby from a user. It is also possible to design the stiffening element 19 such that the outer face 25 facing the user gains a particular design or a particular impression. It is also possible to extend this manufacturing principle to a plurality of layers, or to combine the already produced insulation device 17 in a further process with a material which has other properties. Thus a further foam layer may be applied, for example, in a further step. This may be required, for example, in order to optimize the thermal and/or acoustic properties. In this case, any mixture of materials may be selected in order to achieve optimum acoustic, thermal and/mechanical properties.

FIGS. 7 to 10 show a development of the method according to FIG. 3 in which, instead of a separate stiffening element 19, the door 3, in particular an inner door of the door 3, functions as stiffening element 19 for the insulation device 17. To this end, a mold 28, as mentioned above, having a mold lower part 29 and a mold upper part 30 is used. The mold lower part 29 comprises a cavity 31 for receiving the door 3 and for partially receiving the aforementioned mixture 33 of the basic components of the polyurethane foam 22. The mold upper part 30 comprises a cavity 32.

In a step S1 the insertion of the door 3 into the mold 28 takes place. After closing the mold 28, the mixture 33 of the basic components is introduced in the cavities 31, 32, said basic components then reacting in the closed mold 28. In a step S2 the mixture 33 is introduced into the mold 28. In a step S3 the basic components of the polyurethane foam 22 react with one another and the mixture 33 is foamed in the mold 28, so that the insulation element 18 is foamed onto the door 3. After the curing and/or cross-linking of the mixture 33 to form the polyurethane foam 22 the insulation device 17 is demolded in a step S4.

FIG. 10 shows the mounting of the insulation device 17 shown in FIG. 6 on the receiving area 2. The insulation device 17 is mounted, for example, on the ceiling 8 of the receiving area 2, such that the insulation element 18 bears against the ceiling 8. In other words, the insulation element 18 is arranged between the ceiling 8 and the stiffening element 19. The insulation element 18 may be adhesively bonded or fused, for example, to the ceiling 8. Alternatively, the insulation device 17 may also be positioned loosely on the ceiling 8. Moreover, it is shown in FIG. 10 how the insulation device 17, which is shown in FIG. 9 and which has the door 3 and the insulation element 18, is mounted on the receiving area 2. The door 3 is pivotably mounted on the receiving area 2.

FIGS. 11 to 14 show a further development of the method according to FIG. 3. In this embodiment of the method, initially a plate 34, which can be reshaped to form the receiving area 2, is inserted into a mold 28 as mentioned above. The mold 28 comprises a mold lower part 29 and a mold upper part 30 positioned on the mold lower part 29. The mold lower part 29 comprises a cavity 31 for receiving the plate 34, and the mold upper part 30 comprises a corresponding cavity 32 for receiving the mixture 33 of the basic components.

In a step S1 the stiffening element 19 in the form of the plate 34 is inserted into the mold 28. The mold 28 is then closed and in a step S2 the mixture 33 of the basic components of the polyurethane foam 22 is introduced into the mold 28. In a step S3 the mixture 33 foams in the mold 28 so that the polyurethane foam 22 is formed in order to mold the insulation element 18 onto the plate 34. In this case, as shown in FIG. 12, a plurality of insulation elements 18 may be foamed onto the plate 34.

After the curing and/or cross-linking of the polyurethane foam 22, the insulation device 17 is demolded in a step S4. In a further step S5, after step S4, a step of reshaping the plate 34 to the receiving area 2 takes place. FIG. 13 shows the reshaping according to step S5, wherein arrows indicate the reshaping process and FIG. 14 shows the finished receiving area 2. The reshaping of the plate 34 after attaching the insulation elements 18 has the advantage that the plate 34 has a flat and a simple geometry. A complex construction of the mold 28 is thus able to be dispensed with. Additional polyurethane foam 22 may be kept in the region of bending radii in order to provide a sufficient quantity of polyurethane foam 22 in the region of the bending radii after the reshaping.

By means of the insulation device 17, or by means of the method according to FIG. 3, the mountability of the foam components, in particular the insulation element 18, is improved. The stiffening element 19 improves the mountability and handlability of the insulation device 17. An operationally reliable mounting is made possible by means of the insulation device 17. The mountability is improved by the non-sticky stiffening element 19. Moreover, additional functions may be integrated. Significant shrinkage, stretching and/or elastic deformability are not problematic, due to the improved dimensional accuracy as a result of the stiffening element 19. Subsequent variation and an improved capacity for combinations is possible. A plurality of different materials may be combined together in sandwich form in order to improve the thermal and acoustic properties.

Whilst the invention has been described with reference to exemplary embodiments, it may be modified in many different ways.

### REFERENCE NUMERALS USED

1 Household appliance
2 Receiving area
3 Door
4 Washing chamber
5 Pivot axis
6 Loading opening
7 Bottom
8 Ceiling
9 Rear wall
10 Side wall
11 Side wall
12 Receptacle for items to be washed
13 Receptacle for items to be washed
14 Receptacle for items to be washed
15 Inner face
16 Outer face
17 Insulation device
18 Insulation element
19 Stiffening element
20 Matrix material
21 Pore
22 Polyurethane foam
23 Particle
24 Inner face
25 Outer face
26 Surface
27 Surface
28 Mold
29 Mold lower part
30 Mold upper part
31 Cavity
32 Cavity
33 Mixture
34 Plate
A Pull-out direction (arrow)
d11 Thickness
d18 Thickness
d19 Thickness
E Push-in direction (arrow)
S1 Step
S2 Step
S3 Step
S4 Step
S5 Step

1-15. (canceled)

16. An insulation device for a receiving area of a household appliance, in particular a water-guiding household appliance, said insulation device comprising:
an insulation element made of a viscoelastic polyurethane foam for acoustically insulating the receiving area; and
a stiffening element stiffening the insulation element and firmly connected to the insulation element.

17. The insulation device of claim 16, wherein the polyurethane foam at 40° C. and at a frequency of 100 to 800 Hz has a loss factor of greater than 0.2, preferably of greater than 0.35, further preferably of greater than 0.5.

18. The insulation device of claim 16, wherein the polyurethane foam has a thermal conductivity of between 20 and 80 mW/(m*K), preferably of between 40 and 60 mW/(m*K), further preferably of between 50 and 60 mW/(m*k).

19. The insulation device of claim 16, wherein the polyurethane foam has a density of less than 300 kg/m³, preferably of less than 250 kg/m³, further preferably of less than 200 kg/m³.

20. The insulation device of claim 16, wherein the insulation element has a thickness which is greater than 2 mm, preferably greater than 10 mm, further preferably greater than 15 mm.

21. The insulation device of claim 16, wherein the stiffening element has a thickness which is less than 10 mm, preferably less than 5 mm, further preferably less than 1 mm.

22. The insulation device of claim 16, wherein the stiffening element is part of the receiving area, and is made of a member selected from the group consisting of bitumen, sheet metal, paper, cardboard, aluminum board, plastics, in particular of a plastics film, and wood.

23. The insulation device of claim 16, wherein particles are embedded in the polyurethane foam.

24. The insulation device of claim 16, wherein the polyurethane foam is directly foamed onto the stiffening element.

25. A household appliance, comprising:
a receiving area; and
an insulation device attached to the receiving area such that the insulation element bears against the receiving area, said insulation device comprising an insulation element made of a viscoelastic polyurethane foam for acoustically insulating the receiving area, and a stiffening element stiffening the insulation element and firmly connected to the insulation element.

26. The household appliance of claim 25, constructed in a form of a water-guiding household appliance.

27. A method for manufacturing an insulation device for a receiving area of a household appliance, said method comprising the steps of:
a) inserting a stiffening element into a mold;
b) introducing a mixture of polyurethane basic components into the mold;
c) reacting and foaming the mixture to form a viscoelastic polyurethane foam in order to foam an insulation element made of the polyurethane foam onto the stiffening element, and thus to form the insulation device; and
d) demolding the insulation device.

28. The method of claim 27, wherein the household appliance is a water-guiding household appliance.

29. The method of claim 27, wherein in step a) at least one part of the receiving area is inserted into the mold as the stiffening element.

30. The method of claim 29, wherein in step a) a door of the receiving area is inserted into the mold as the stiffening element.

31. The method of claim 29, wherein in step a) a plate, capable of being reshaped to form the receiving area, is inserted into the mold as the stiffening element.

32. The method of claim 31, further comprising reshaping the plate to the receiving area after step d).
